(19) United States
(12) Patent Application Publication
(10) Pub. No.: US 2014/0160726 A1
(43) Pub. Date: Jun. 12, 2014

(54) LIGHTING DEVICE

(71) Applicants: Peng Chen, Shenzhen (CN); Tingming Liu, Shenzhen (CN); Shengmei Zheng, Shenzhen (CN)

(72) Inventors: Peng Chen, Shenzhen (CN); Tingming Liu, Shenzhen (CN); Shengmei Zheng, Shenzhen (CN)

(73) Assignee: OSRAM GMBH, Muenchen (DE)

(21) Appl. No.: 14/232,625

(22) PCT Filed: Jul. 12, 2012
(86) PCT No.: PCT/EP2012/063727

§ 371 Date: Feb. 7, 2014

(30) Foreign Application Priority Data
Jul. 15, 2011 (CN) 201110201978.0

(51) Int. Cl. F21K 99/00; F21V 29/00

(52) U.S. Cl. CPC F21K 9/56; F21V 29/22
USPC 362/84

(57) ABSTRACT

A lighting device may include a circuit board, at least one LED lighting chip provided on one side of the circuit board, and a phosphor layer arranged to enclose the LED lighting chip, wherein the phosphor layer has different thicknesses at different light emergence angles.

### RELATED APPLICATIONS

The present application is a national stage entry according to 35 U.S.C. §371 of PCT application No.: PCT/EP2012/063727 filed on Jul. 12, 2012, which claims priority from Chinese application No.: 201110201978.0 filed on Jul. 15, 2011, and is incorporated herein by reference in its entirety.

### TECHNICAL FIELD

Various embodiments relate to a lighting device.

### BACKGROUND

Currently, light emitting diode (LED) lighting devices has been widely used in daily life. Such lighting devices may emit white light or white-like light.

However, since white light is mixed light, ideal white light is obtained mainly by a light mixing process in the LED lighting devices in the prior art. The emitted white light directly passes through the cover of the lighting device to be incident on an object.

There exists a technical concept of using a blue LED for realizing the emission of white light, in which white light is obtained by mixing light through setting the blue LED and a phosphor layer, viz. the blue light emitted by the blue LED passes through the phosphor layer to be converted into yellow light and this yellow light and the rest of blue light are mixed to become white light.

Since the light distribution from the LED is usually not uniform in all directions in the prior art, the blue/yellow ratio is not a fixed value in different directions when the blue light interacts with the phosphor layer to form white light, leading to non-uniform angular CCT distribution.

### SUMMARY

Various embodiments provide a lighting device, which may realize uniform angular CCT distribution.

The lighting device according to the present disclosure includes a circuit board, a LED lighting chip provided on one side of the circuit board, and a phosphor layer arranged to enclose the LED lighting chip, wherein the phosphor layer has different thicknesses at different light emergence angles.

Various embodiments relate to a solution of compensating CCT by adjusting the thickness of the phosphor layer so as to realize relatively uniform CCT. The inventor has found that, in the case where the thickness of the phosphor layer is unchanged, CCT values at respective angels decrease in a direction from the position where light is emitted perpendicularly to the positions at two sides where the light is emitted horizontally, and the above difference is very large. The inventor firstly provide the solution that the ratio of the light generated by a LED to the light generated by exciting the phosphor layer is adjusted by adjusting the thickness of the phosphor layer at different light emergence angles so as to realize uniform CCT.

Preferably, the thickness of the phosphor layer increases with the increase of the intensity of light incident on the phosphor layer. Accordingly, the thickness of the phosphor layer is larger at the position where the light intensity is higher, while the thickness of the phosphor layer is smaller at the position where the light intensity is lower, such that the ratio of the light generated by the LED to the light generated by exciting the phosphor layer is adjusted to realize uniform CCT.

Preferably, the phosphor layer is arc-shaped. Other suitable shape also may be considered.

Preferably, the LED lighting chip is a blue LED chip, such that the ratio of blue light to yellow light is adjusted to realize uniform CCT. Other LED lighting chips generating white light by mixing fluorescent light may certainly be used.

Preferably, the phosphor layer has a thickness matching with the light distribution of the blue LED chip and has a thickness distribution gradually decreasing from the position where the light emergence angle is 90° in a direction towards 0° or 180°.

Preferably, the maximum thickness of the phosphor layer at the position where the light emergence angle is 90° is 1.5 mm and the minimum thickness thereof at the position where the light emergence angle is 0° or 180° is 0.7 mm. The above values can achieve excellent CCT distribution.

Preferably, the phosphor layer is distributed in a range of light emergence angle from 0 to 180°, thereby forming a semicircular phosphor layer.

Preferably, the phosphor layer is arranged a certain distance away from the LED lighting chip. This means that a certain distance exists between the phosphor layer and the LED chip, thereby ensuring that the heat generated by the LED in the operating state slightly affects the temperature of the phosphor in the phosphor layer. Preferably, in the case where a plurality of the LED lighting chips are arranged, the distance is greater than or equal to a distance between every two LED lighting chips. Thus, the negative effect of the heat to the phosphor can be substantially eliminated.

According to one preferred solution of the present disclosure, the phosphor layer is made of plastic doped with phosphor. Such design may advantageously reduce the weight of the lighting device itself and reduce the interface passed by the emitted light. The phosphor suitable for the LED light source may be, e.g., YAG phosphor, nitride phosphor, and silicate phosphor.

According to one alternative preferred solution of the present disclosure, there is also included a light-transmissive cover, the inner surface of which facing the LED lighting chip is coated with the phosphor layer, thereby allowing for a relatively simple manufacturing process.

Preferably, the phosphor layer includes phosphor and silicon epoxy.

Preferably, the lighting device further includes a heat sink, which is provided on the other side of the circuit board and engages the phosphor layer or the light-transmissive cover coated with the phosphor layer to define an enclosed cavity accommodating the circuit board provided with the LED lighting chip. The flexible engagement of the plastic phosphor layer with the heat sink realizes a simply-structured locking configuration.

Preferably, the heat sink and the phosphor layer or the light-transmissive cover coated with the phosphor layer define a tubular profile, thereby obtaining a solution with a simpler structure, a better appearance, and higher universality.

Preferably, a heat conducting glue is provided between the heat sink and the circuit board, which may fix the heat sink and the circuit board in a simple way and achieve better heat conduction performance.

The lighting device according to the present disclosure may achieve uniform angular CCT distribution, which improves significantly the performance of the lighting device.

### BRIEF DESCRIPTION OF THE DRAWINGS

In the drawings, like reference characters generally refer to the same parts throughout the different views.

The drawings are not necessarily to scale, emphasis instead generally being placed upon illustrating the principles of the disclosed embodiments. In the following description, various embodiments described with reference to the following drawings, in which:

FIG. 1 is a view of typical LED light intensity distribution;

FIG. 2 is another curve chart of a change of CCT value when using a lighting device having a phosphor layer with a uniform thickness;

FIG. 3 is a stereoscopic view of a lighting device according to the present disclosure;

FIG. 4 is an enlarged cross-sectional view of a lighting device according to the present disclosure, wherein the structure of a phosphor layer is shown clearly; and

FIG. 5 is a view of CCT distribution of a lighting device according to the present disclosure, wherein it is clearly shown that the lighting device according to the present disclosure achieves uniform CCT distribution.

### DETAILED DESCRIPTION

The following detailed description refers to the accompanying drawing that show, by way of illustration, specific details and embodiments in which the disclosure may be practiced.

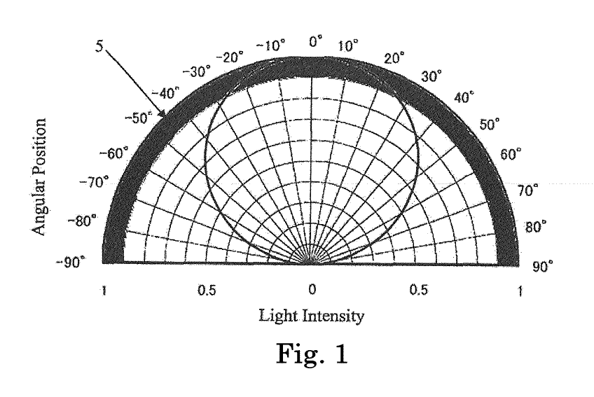

FIG. 1 is a view of typical LED light intensity distribution (lambertian type). From the figure, it can be seen that the LED light intensities are different in respective directions. Generally, the light intensity at the perpendicular angular position is the highest and is the lowest at the horizontal angular position. The thick black line indicates a uniform phosphor layer. It can be seen that the ratios of the LED light intensity to the amount of phosphor are different in different directions, resulting in that the CCT is nonuniform.

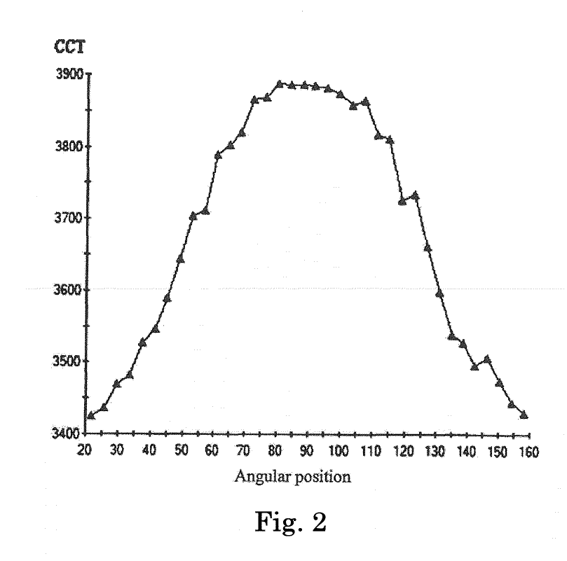

FIG. 2 is another curve chart of a change of CCT value when using a lighting device having a phosphor layer, wherein it can be seen that the difference between the CCT value of the perpendicular angular position and that of the horizontal angular positions at two sides is up to 500K, resulting in obvious non-uniform CCT distribution.

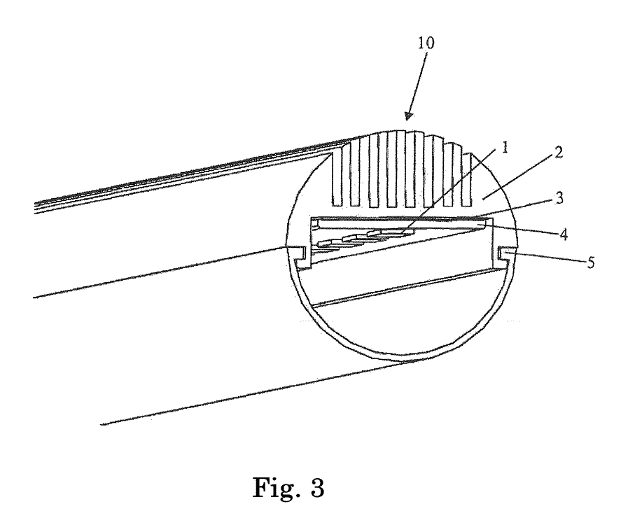

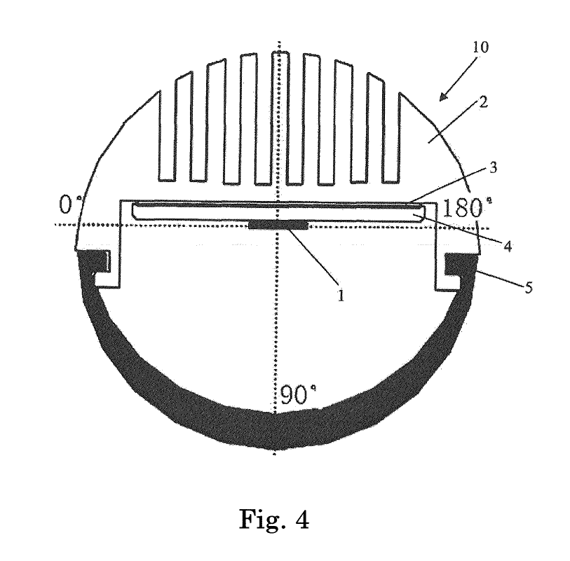

FIG. 3 is a stereoscopic view of a lighting device 10 according to the present disclosure. The lighting device 10 is merely used for illustrating the overall layout of the lighting device. The phosphor layer 5 having different thicknesses at different light emergence angles, as mentioned in the present disclosure, is shown clearly in said figure (as can also be seen from FIG. 4). The lighting device 10 according to the present disclosure comprises a circuit board 4, a LED lighting chip 1 provided on one side of the circuit board 4 and a heat sink 2 provided on the other side of the circuit board 4, wherein the heat sink 2 and the phosphor layer 5 engage with each other to define a tubular profile and an enclosed cavity accommodating the circuit board 4 provided with the LED lighting chip 1. A heat conducting glue 3 is provided between the heat sink 2 and the circuit board 4 for realizing the functions of adhesion and heat dissipation, wherein the LED lighting chip 1 is preferably a blue LED chip, by which yellow light is generated via exciting the phosphor layer 5 and is mixed to emit white light. Since the thickness of the phosphor layer 5 is designed as non-uniform and varies with the light intensity, better CCT distribution can be achieved.

The lighting device according to the present disclosure may be designed as a tubular shape, which has high universality. Certainly, other different shapes may be designed depending on the application fields.

FIG. 4 is an enlarged cross-sectional view of a lighting device 10 according to the present disclosure, wherein the structure of the phosphor layer 5 is shown clearly. The thickness of the phosphor layer 5 is designed as non-uniform, viz. said thickness is not constant but varies continuously with the angular position. According to FIG. 1 and FIG. 2, it can be determined that the CCT at the perpendicular angular position is far higher than that at the position close to the horizontal angular position when using the phosphor layer with a constant thickness. In order to reduce the difference between the CCT value of the perpendicular angular position and that of the horizontal angular position, the phosphor layer of the present disclosure decreases continuously in a direction from the perpendicular angular position to the horizontal angular position. The thickness at the perpendicular angular position is designed as a maximum value, such that a lower CCT value can be obtained by adjusting the ratio of blue light to yellow light.

The phosphor layer 5 can be designed to be formed on a transparent cover 6 enclosing at least one LED lighting chip. The inner surface of the transparent cover 6 facing the LED lighting chip 1 is coated with a phosphor layer comprising phosphor and silicon epoxy or the phosphor layer 5 may be made of plastic doped with phosphor. The transparent cover 6 coated with the phosphor layer 5 or the phosphor layer 5 made of plastic doped with phosphor may be designed as suitable shapes such as an arc shape or an arch shape and has a locking part which forms an enclosed space with the heat sink 2, forming a package structure for the LED lighting chip 1.

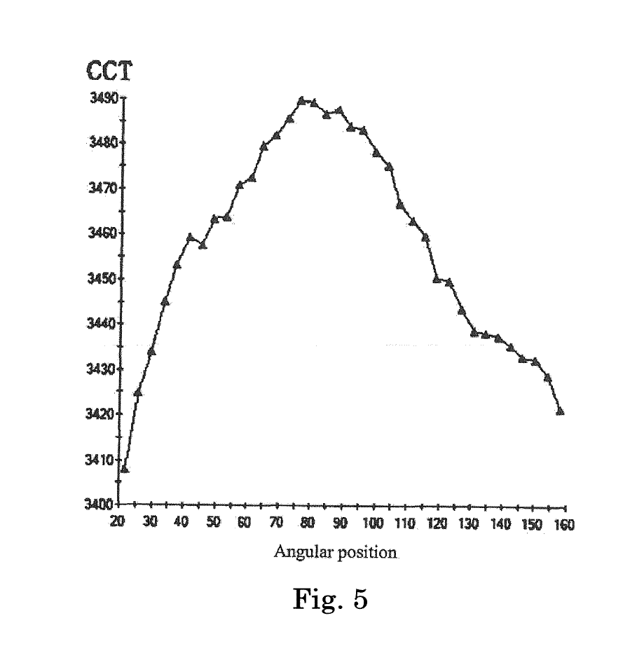

FIG. 5 is a view of CCT distribution of a lighting device according to the present disclosure, wherein it is clearly shown that the lighting device according to the present disclosure achieves uniform CCT distribution. The difference between the CCT value of the perpendicular angular position and that of the horizontal angular positions at two sides is merely 80K, and such a CCT difference may not be visualized.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCE SIGNS

1 LED lighting chip
2 heat sink
3 heat conducting glue 4 circuit board
5 phosphor layer
6 light-transmissive cover
10 lighting device

1. A lighting device, comprising a circuit board, at least one LED lighting chip provided on one side of the circuit board, a phosphor layer arranged to enclose the LED lighting chip , wherein the phosphor layer has different thicknesses at different light emergence angles.

2. The lighting device according to claim 1, wherein the thickness of the phosphor layer increases with the increase of the intensity of light incident on the phosphor layer.

3. The lighting device according to claim 2, wherein the LED lighting chip is a blue LED chip.

4. The lighting device according to claim 3, wherein the phosphor layer has a thickness matching with the light distribution of the blue LED chip and has a thickness gradually decreasing from the position where the light emergence angle is 90° in a direction towards 0° or 180°.

5. The lighting device according to claim 1, wherein the maximum thickness of the phosphor layer at the position where the light emergence angle is 90° is 1.5 mm and the minimum thickness thereof at the position where the light emergence angle is 0°or 180° is 0.7 mm.

6. The lighting device according to claim 1, wherein the phosphor layer is distributed in a range of light emergence angle from 0 to 180°.

7. The lighting device according to claim 1, wherein the phosphor layer is arranged a certain distance away from the LED lighting chip.

8. The lighting device according to claim 7, wherein the number of the LED lighting chip is more than one, and the distance is greater than or equal to a distance between every two LED lighting chips.

9. The lighting device according to claim 1, wherein the phosphor layer is arc-shaped.

10. The lighting device according to claim 1, wherein the phosphor layer is made of plastic doped with phosphor.

11. The lighting device according to claim 1, further comprising a light-transmissive cover, the inner surface of which facing the LED lighting chip is coated with the phosphor layer.

12. The lighting device according to claim 11, wherein the phosphor layer comprises phosphor and silicon epoxy.

13. The lighting device according to claim 11, further comprising a heat sink, which is provided on the other side of the circuit board and engages the phosphor layer or the light-transmissive cover coated with the phosphor layer to define an enclosed cavity accommodating the circuit board provided with the LED lighting chip.

14. The lighting device according to claim 13, wherein the heat sink and the phosphor layer or the light-transmissive cover coated with the phosphor layer define a tubular profile.

15. The lighting device according to claim 13, wherein a heat conducting glue is provided between the heat sink and the circuit board.
